(19) United States
(12) Patent Application Publication
(10) Pub. No.: US 2025/0047025 A1
(43) Pub. Date: Feb. 6, 2025

(54) ELECTRICAL SOCKET CONTACT

(71) Applicant: KOSTAL Kontakt Systeme GmbH & Co. KG, Luedenscheid (DE)

(72) Inventor: Eduard CVASA, Bochum (DE)

(73) Assignee: KOSTAL Kontakt Systeme GmbH & Co. KG, Luedenscheid (DE)

(21) Appl. No.: 18/921,865

(22) Filed: Oct. 21, 2024

Related U.S. Application Data
(63) Continuation of application No. PCT/EP2023/065705, filed on Jun. 13, 2023.

(30) Foreign Application Priority Data
Jun. 17, 2022 (DE) 102022002194.3

(51) Int. Cl. H01R 13/187

(52) U.S. Cl. CPC H01R 13/187

(57) ABSTRACT

A socket contact for accommodating a flat contact includes a base body and two mutually opposed lamella bodies arranged on inner surfaces of two mutually opposed side parts of the base body, respectively. Each lamella body is formed as an insert mat from a metal sheet. A flat contact is insertable along an insertion direction into the base body between the lamella bodies. Each lamella body includes lamellas that are arranged in rows perpendicular to the insertion direction and in columns along the insertion direction. Each lamella includes a metal strip having first and second lamella legs that are folded against one another. The lamella legs folded against one another form a slope that ascends along the insertion direction.

### CROSS-REFERENCE TO RELATED APPLICATIONS

This application is a continuation of International Application No. PCT/EP2023/065705, filed Jun. 13, 2023, which claims priority to DE 10 2022 002 194.3, filed Jun. 17, 2022, the disclosures of which are hereby incorporated in their entirety by reference herein.

### TECHNICAL FIELD

The present invention relates to an electrical socket contact for high-current applications, the socket contact including a base body for accommodating a flat contact, the base body having two opposite side parts in parallel with one another and two mutually opposed lamella bodies situated at the inner sides of the side parts.

### BACKGROUND

This type of socket contact is known from German patent application DE 10 2004 015 345 A1 (corresponds to U.S. Pat. No. 7,241,189). In this socket contact, contact lamellas are situated on one side of the base body of a contact lamella insert. The contact lamellas extend radially from edge areas of the base body to its center. In the area of their free end, the contact lamellas each form contact sections which contact the attached mating plug (mating connector).

This arrangement has only a relatively small number of contacts. If the contact lamellas are reduced in size to increase their number, then the contact force acting on the flat contact due to the contact lamellas being fixed at one side is also reduced.

Socket contacts with contact lamellas, in the form of lamella cages, often form relatively long current paths to the attached mating plug. These long current paths cause power loss and thus a reduced current carrying capacity.

Contact parts having a lamella body often experience an increase in length (longitudinal expansion) during the insertion process of a flat contact. To provide the necessary space, fixing the lamella body on both sides is not possible without significantly increasing the insertion force.

### SUMMARY

An object is to provide a generic socket contact that does not have these drawbacks, or at least has them to a greatly reduced extent.

In embodiments of the present invention, an electrical socket contact for high-current applications includes a base body for accommodating a flat contact (i.e., for receiving a flat contact inserted therein). The base body has two mutually opposed side parts. The opposite side parts may be situated in parallel to one another. Two mutually opposed lamella bodies are situated, respectively, on the inner surfaces of the side parts. The flat contact is insertable into the base body along an insertion direction between the lamella bodies on the inner surfaces of the side parts.

Each lamella body is formed as an insert mat by punching and bending technology. Each lamella body is made of a plurality of identical contact lamellas. The lamellas are arranged in columns along the insertion direction and are arranged in rows perpendicular to the insertion direction. As such, each lamella body along the insertion direction has columns made up of multiple identical lamellas, and each lamella body perpendicular to the insertion direction has rows made up of multiple identical lamellas. The identical columns of lamellas may be arranged in parallel to one another along the insertion direction and the identical rows of lamellas may be arranged in parallel to one another perpendicular to the insertion direction. Each lamella has two sections of a metal strip folded against one another. The sections folded against one another form a slope that ascends in the insertion direction.

Embodiments of the present invention achieve the object and/or other objects in that the lamella bodies are formed as insert mats by punching and bending technology, each lamella body in the insertion direction has columns made up of multiple identical lamellas and perpendicular to the insertion direction has multiple identical rows arranged in parallel, each lamella has two sections of a metal strip folded against one another, and the sections folded against one another form a slope that ascends in the insertion direction.

It is advantageous that each lamella body formed (shaped) as an insert mat may have a relatively large number of lamellas per unit surface area. The relatively large number of lamellas thus form a relatively large number of independent contact points to the mating plug and to the inner surfaces of the side parts of the base body of the socket contact.

In this way, both the thermal resistance and the electrical resistance are distributed over a relatively large number of points in a relatively large surface area and are kept low overall. As a result, “hot spots” are effectively avoided.

It is advantageous that a relatively large number of current paths are created between the base body and mating plug, all of which can be kept quite short.

It is advantageous that the surface areas of the lamella bodies may be easily adapted to the size of the respective base bodies.

It is advantageous that the lamella bodies are easily fixable to the base body with respect to the insertion direction. This is a result of the lamellas of a lamella body being able to be pressed down during the insertion process to a certain extent without increasing in length.

### BRIEF DESCRIPTION OF THE DRAWINGS

Advantageous embodiments and refinements of the present invention arise from the following description of embodiments of the present invention with reference to the drawings, which show the following:

FIG. 1 illustrates a sectional view of an electrical socket contact in accordance with a first embodiment;

FIG. 2 illustrates an individual contact lamella of the socket contact;

FIG. 3 illustrates a side view of the socket contact according to FIG. 1;

FIG. 4 illustrates a side view of the socket contact in accordance with a second embodiment; and

FIG. 5 illustrates a half of the socket contact according to FIG. 4.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of components. Therefore, specific structural and functional details disclosed herein are not to be interpreted as limiting, but merely as a representative basis for teaching one skilled in the art to variously employ the present invention.

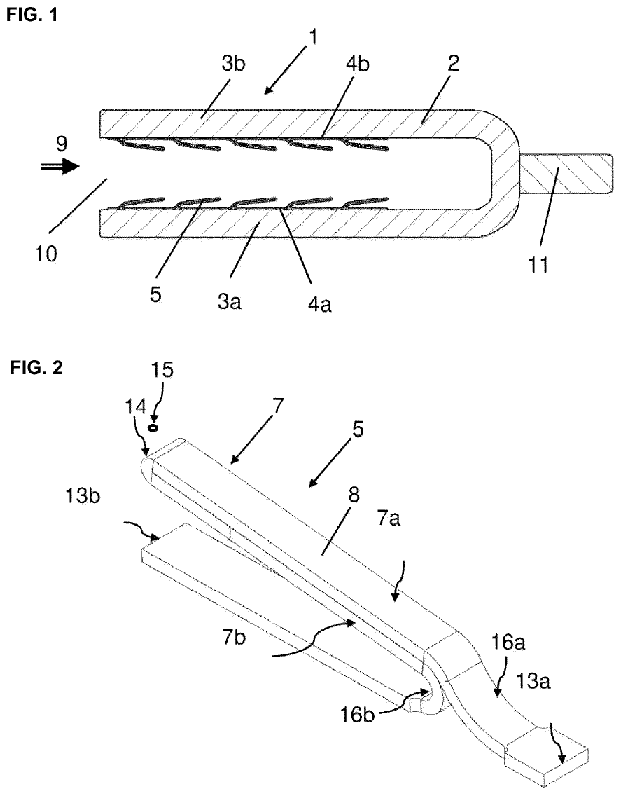

FIG. 1 shows a sectional view of an electrical socket contact 1 (electrical receptacle contact; plug-in sleeve contact) in accordance with a first embodiment. Socket contact 1 is generally an integral part of a plug connector part (not shown). The plug connector part includes one or more socket contacts 1. The one or more socket contacts 1 of the plug connector part are situated in a housing made of insulation material.

Socket contact 1 includes a base body 2. Base body 2 is a metal strip that is bent in a U-shape. The U-shape, metal strip forms two U-shaped legs 3a, 3b. U-shaped legs 3a, 3b form first and second side parts of base body 2. Side parts 3a, 3b of base body 2 are opposite from one another and may be oriented in parallel to one another. Socket contact 1 further includes a metallic connection area 11. Base body 2 is connected to connection area 11.

Base body 2 is for accommodating a flat contact (not shown) inserted therein. The flat contact is of a mating plug connector part (not shown). The flat contact is insertable into base body 2 along an insertion direction 9 (plug-in direction).

Socket contact 1 further includes two lamella bodies 4a, 4b (lamellar bodies, slat bodies). Lamella bodies 4a, 4b are respectively situated on the inner surfaces of side parts 3a, 3b of base body 2. As such, lamella bodies 4a, 4b are mutually opposed from one another. The flat contact is inserted between lamella bodies 4a, 4b along insertion direction 9 when inserted into base body 2. Lamella bodies 4a, 4b are situated on the inner surfaces of side parts 3a, 3b preferably via riveting or welding.

Each lamella body 4a, 4b is made from a metal sheet using punching (stamping) and bending technology. Each lamella body 4a, 4b is formed (shaped) as a one-piece or multi-piece insert mat. Each lamella body 4a, 4b includes a plurality of contact lamellas 5 (lamellae, slats, contacts, contact blades). Lamellas 5 may be identical to one another. Lamellas 5 are inclined opposite insertion direction 9, as shown in FIG. 1. Each individual lamella 5 establishes a punctiform (i.e., point-like) electrical connection with a flat contact inserted into base body 2. The punctiform contact point is indicated in FIG. 2 by a marked contact point 15.

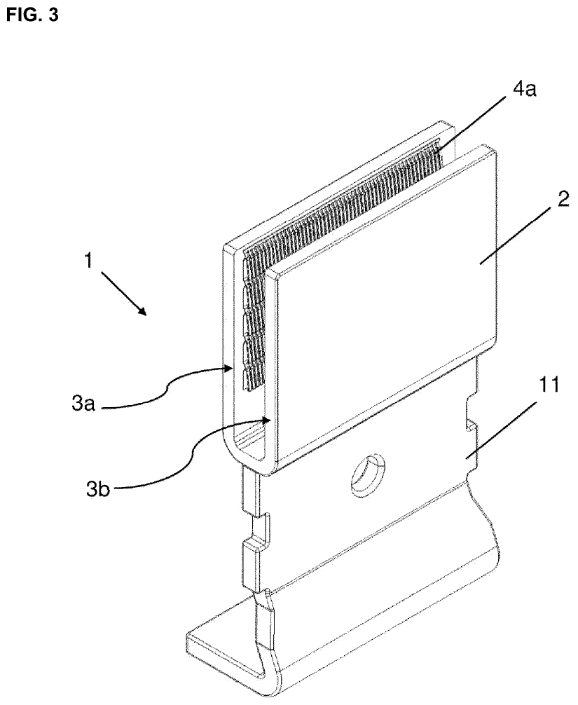

FIG. 3 shows a side view of socket contact 1 in accordance with the first embodiment. Connection area 11 connected to base body 2, bent in a U-shape, is illustrated here as a welded connection strictly by way of example. Alternatively, connection area 11 can be a screwed, riveted, or crimped connection.

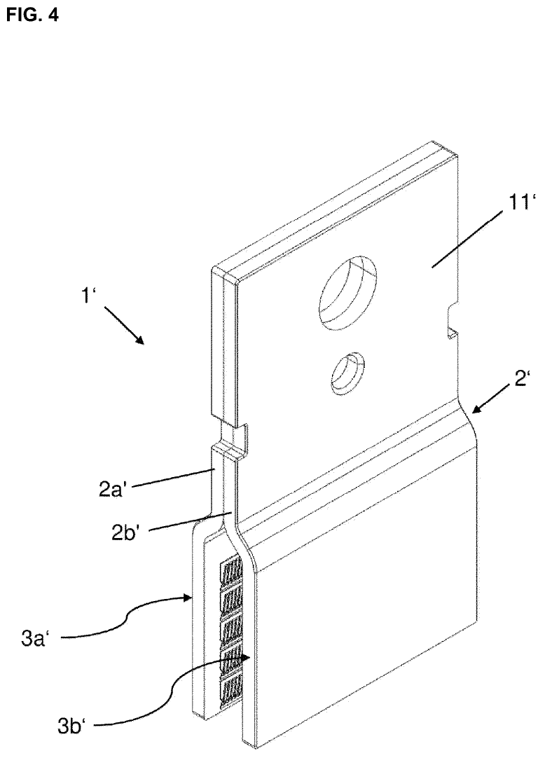

FIG. 4 shows a socket contact l′ in accordance with a second embodiment. In this case, base body 2′ with its parallel side parts 3a′, 3b′ is made up of two identical base body halves 2a′, 2b′ that are joined and connected. Base body halves 2a′, 2b′ together form a connection area 11′.

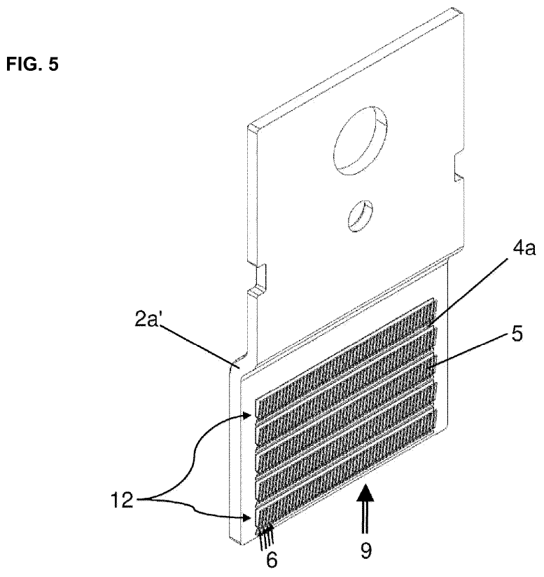

FIG. 5 shows an individual base body half 2a′ with lamella body 4a situated thereon. It is particularly clear here that the one-piece lamella body 4a is made up a plurality of lamellas 5 arranged in multiple rows 12 and in multiple columns 6. Lamella rows 12 are perpendicular to insertion direction 9, and lamella columns 6 are along the insertion direction. Identical lamella rows 12 may be arranged in parallel to one another perpendicular to insertion direction 9, and identical lamella columns 6 may be arranged in parallel to one another along the insertion direction.

In the illustrated design, lamella body 4a has, strictly by way of example, five lamella rows 12, each with fifty-three lamellas 5. Lamellas 5, connected to one another along insertion direction 9, thus form fifty-three lamella columns 6 situated in parallel to one another.

Lamella body 4a illustrated in FIG. 5 thus has two hundred and sixty-five individual lamellas 5. In a fully assembled plug connection, as illustrated in FIG. 4, the total number of lamellas is even twice as large, due to a second lamella body situated on the opposite base body half 2b′ on the inner surface of second side part 3b′.

This number of lamellas is of course just an example, because on the one hand the size of lamella bodies 4a, 4b may be adapted to the size of base body 2, 2′, and on the other hand the size of an individual lamella 5, and thus conversely the number of lamellas 5 of a lamella body 4a, 4b, are largely scalable.

FIG. 2 shows the shape of an individual lamella 5. Lamella 5 is made up of a folded metal strip 7. Metal strip 7 has a first contact surface 13a at one end of lamella 5 and a second contact surface 13b at another end of lamella 5. Second contact surface 13b is formed by a simple, relatively long section of metal strip 7. First contact surface 13a is much shorter and establishes one-piece connections with contact surfaces 13a of lamellas 5 of neighboring lamella columns 6 (not shown here). This results in a relatively stable structure for lamella bodies 4a, 4b.

For each lamella 5 that is not situated at the beginning or end of a lamella column 6, first contact surface 13a of the lamella adjoins second contact surface 13b of the neighboring lamella 5 in lamella column 6, and vice versa. At least at the beginning or end of a lamella column 6, contact surfaces 13a, 13b at the same time form fixing points of lamella bodies 4a, 4b to base body 2, 2′.

As indicated, lamella 5 is made up of folded metal strip 7. Particularly, metal strip 7 has two lamella legs 7a, 7b (sections, slat legs) that are folded against one another. First and second lamella legs 7a, 7b (lamella sections) are respectively connected in an elastically movable (spring movable) manner to contact surfaces 13a, 13b. Particularly, lamella legs 7a, 7b are connected to contact surfaces 13a, 13b via respective rounded sections of metal strip 7. The first rounded section of metal strip 7 forms a first spring 16a and the second rounded section of metal strip 7 forms a second spring 16b. Springs 16a, 16b (spring elements) may have the same or different spring rates.

The two lamella legs 7a, 7b are folded against one another by approximately 180° at a connecting point 14. First and second lamella legs 7a, 7b may be situated either in parallel and on top of one another, as shown in FIG. 2, or spaced apart to increase the geometrical moment of inertia of lamella 5. Lamella legs 7a, 7b folded against one another form a slope 8 that ascends in insertion direction 9, which in each case forms a punctiform contacting point 15 for the flat contact to be inserted into base body 2.

The two spring elements 16a, 16b of each lamella 5 allow lamella legs 7a, 7b of the lamella to carry out a tilting movement under a compression (pressure) load without changing the spacing between contact surfaces 13a, 13b of the lamella.

It is thus possible to fix the lamella bodies 4a, 4b to base body 2, 2′, for example by riveting, without an excessive increase in the force for pressing down lamellas 5, and thus in the insertion force for the flat contact to be inserted.

After each lamella body 4a is installed or mounted on base body 2, all contact surfaces 13a, 13b of lamellas 5 of lamella body 4a rest against the inner surface of first side part 3a of the base body, thus establishing electrical connections with the base body. Likewise, after each lamella body 4b is installed or mounted on base body 2, all contact surfaces 13a, 13b of lamellas 5 of lamella body 4b rest against the inner surface of second side part 3b of the base body, thus establishing electrical connections with the base body. Via the two lamella legs 7a, 7b of each lamella 5, in each case this results in two current paths to the neighboring contact surfaces 13a, 13b.

Due to a plurality of current paths, a relatively good electrical connection results on the one hand between lamella bodies 4a, 4b and base body 2, and on the other hand between lamella bodies 4a, 4b and the inserted flat contact, and thus ultimately between socket contact 1 and the inserted flat contact.

### LIST OF REFERENCE NUMERALS

1, 1′ socket contact (receptacle contact; plug-in sleeve contact)
2, 2′ base body
2a′, 2b′ base body halves
3a, 3b, 3a′, 3b′ side parts (U-shaped legs)
4a, 4b lamella bodies (lamellar bodies, slat bodies)
5 contact lamellas (lamellae, slats, contacts, contact blades)
6 columns (lamella columns)
7 metal strip
7a, 7b lamella legs, sections (slat legs)
8 slope
9 insertion direction (plug-in direction)
10 insertion opening
11, 11′ metallic connection area
12 rows (lamella rows)
13a, 13b contact surfaces
14 connecting point
15 contacting point
16a, 16b springs (spring elements)

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A socket contact for accommodating a flat contact, the socket contact comprising:
a base body having two mutually opposed side parts;
two mutually opposed lamella bodies arranged on inner surfaces of the side parts, respectively, each lamella body being formed as an insert mat from a metal sheet;
wherein a flat contact is insertable along an insertion direction into the base body between the lamella bodies;
each lamella body includes a plurality of lamellas, the lamellas of each lamella body are arranged in rows perpendicular to the insertion direction and in columns along the insertion direction; and
each lamella includes a metal strip having first and second lamella legs that are folded against one another, the first and second lamella legs folded against one another form a slope that ascends along the insertion direction.

2. The socket contact of claim 1 wherein:
the metal strip of each lamella further includes a first contact surface at one end of the lamella and a second contact surface at another end of the lamella, the first and second contact surfaces contacting the inner surface of the side part of the base body on which the lamella body of the lamella is arranged.

3. The socket contact of claim 2 wherein:
the second contact surface is longer than the first contact surface.

4. The socket contact of claim 2 wherein:
the first lamella leg is connected to the first contact surface and the second lamella leg is connected to the second contact surface.

5. The socket contact of claim 4 wherein:
the metal strip of each lamella further includes a first rounded section forming a first spring and a second rounded section forming a second spring, the first lamella leg being elastically connected to the first contact surface via the first spring, and the second lamella leg being elastically connected to the second contact surface via the second spring.

6. The socket contact of claim 5 wherein:
the springs have different spring rates.

7. The socket contact of claim 5 wherein:
the springs have a same spring rate.

8. The socket contact of claim 2 wherein:
the first contact surfaces of the lamellas in adjacent columns are in contact with one another.

9. The socket contact of claim 2 wherein:
the first contact surfaces of some of the lamellas in each column are in contact with the second contact surfaces of the lamellas in adjacent rows of the column.

10. The socket contact of claim 1 wherein:
the side parts of the base body are mutually opposed parallel to one another.

11. The socket contact of claim 1 wherein:
the lamellas of at least one of the lamella bodies are identical.

12. The socket contact of claim 1 wherein:
the lamella bodies are identical.

13. The socket contact of claim 1 wherein:
the rows of lamellas are identical to one another; and
the columns of lamellas are identical to one another.

14. The socket contact of claim 1 wherein:
the rows of lamellas are parallel to one another.

15. The socket contact of claim 1 wherein:
the columns of lamellas are parallel to one another.

16. The socket contact of claim 1 wherein:
the first and second lamella legs are folded against one another by 180° at a connecting point.

17. The socket contact of claim 16 wherein:
the first and second lamella legs folded against one another at the connecting point form a punctiform contacting point for contacting a flat contact inserted along the insertion direction into the base body between the lamella bodies.

18. The socket contact of claim 1 wherein:
the first and second lamella legs are U-shaped legs.

19. The socket contact of claim 1 wherein:
the first and second lamella legs are situated in parallel and on top of one another.

20. The socket contact of claim 1 wherein:
each lamella body is formed as the insert mat from the metal sheet via the metal sheet being punched and bent.
